(19) United States
(12) Patent Application Publication
(10) Pub. No.: US 2008/0107257 A1
(43) Pub. Date: May 8, 2008

(54) Pillow Telephone

(76) Inventor: Odwin John Matthews, Brooklyn, NY (US)

Correspondence Address: Odwin Matthews, 101 Sands Street, Fort Bragg, NC, 28307, US

(21) Appl. No.: 11/557,080

(22) Filed: Nov. 6, 2006

(51) Int. Cl. H04M 1/00

(52) U.S. Cl. 379/420.02

(57) ABSTRACT

This product makes it easier to have long conversation while in bed without having to hold the phone up to your ear for long periods of time or having a head phone clamp tightly around or stuck in your ear. Your audio is clear as ever and you don't even have to talk into the pillow, just talk regular and the conversation is still private unlike using a speakerphone.

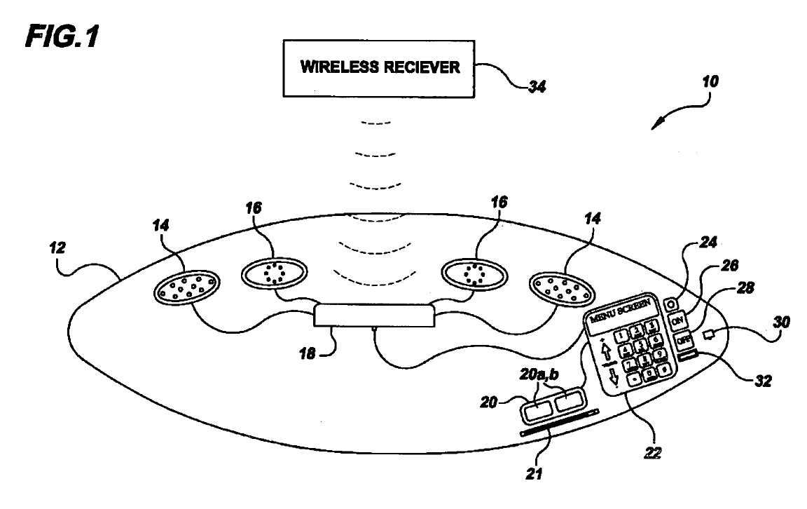

The present invention relates to a telephone in a pillow allowing the user to take or make a late call without even raising his or her head from the pillow. The device consists of a family size pillow or larger made of regular foam, with two sets mini flat high frequency speakers and microphones buried inside as a regular phone and connected to the keypad/menu panel, which is made of soft plastic and the number keys and high/low volume all soft bubble touch. The screen is flat like a calculator and small also cover by plastic, which can all be found on the lower right side. The receiver is mounted close to the bed and the pillow works like the hand-set to keep you connected wireless like a cordless phone would.

You receive a phone call to your phone and the receiver picks the signal up and transfers it to your pillow like a cordless phone and with a touch of any key on the side panel you can answer the call. And because you have two sets of speakers and microphones it doesn't matter which direction you are facing you will still be able to have a good conversation.

This product can also be use as wireless surround speakers for your bedroom TV when not in phone mode or can carry a separate plastic pocket compartment which is compatible for use with many present day mp3 devices for plug and play, of course in these two modes should someone try to reach you it automatically switch to phone mode and you can take that call.

What is claimed is:

1. A telephone in a pillow that allows the user to take or make a late call without even raising his or her head from the pillow. This product works much like a regular phone but much more comfort and privacy. Instead of having a loud phone wake up the entire room, the phone pillow just wakes up the person the call is for. With a steady vibration or soft music of your choice, your pillow will let you know that someone is trying to reach you on the phone and with a press on any key on the lower right side you can take that call.
